(19) United States
(12) Patent Application Publication
(10) Pub. No.: US 2018/0010477 A1
(43) Pub. Date: Jan. 11, 2018

(54) PIPELINE-TRANSPORT COMPRESSOR INCLUDING COOLER UNIT AND AIR EXHAUST POWER GENERATION UNIT

(71) Applicants: James Leslie STEWART, Okotoks (CA); Darcy William MCINTOSH, Okotoks (CA); Stephen Allan MORGAN, Okotoks (CA)

(72) Inventors: James Leslie STEWART, Okotoks (CA); Darcy William MCINTOSH, Okotoks (CA); Stephen Allan MORGAN, Okotoks (CA)

(21) Appl. No.: 15/205,094

(22) Filed: Jul. 8, 2016

(51) Int. Cl. F01D 15/10; F04D 25/08; F04B 39/06; H02K 7/18; F04D 29/32

(52) U.S. Cl. CPC F01D 15/10; H02K 7/1823; F04D 29/325; F04B 39/066; F04D 25/08; F05D 2220/76

(57) ABSTRACT

An apparatus includes a pipeline-transport compressor configured to receive, in use, a product stream from a pipeline. The cooler unit is configured to receive, in use, a cooler air intake from the pipeline-transport compressor. This is done in such a way that removal of the cooler air intake by the cooler unit, in use, moves the cool air across the cooler bundles and out through the cooler unit, and cools the pipeline-transport compressor. An air exhaust power generation unit is configured to generate, in use, electric power in response to the cooler unit, in use, urging, at least in part, the cooler air intake toward, at least in part, the air exhaust power generation unit.

### TECHNICAL FIELD

This document relates to the technical field of (and is not limited to) an apparatus including a synergistic combination of a pipeline-transport compressor including a cooler unit and an air exhaust power generation unit.

### BACKGROUND

Pipeline transport is the transportation of flowable goods or material through a pipe. As of 2014, there is a total of about 3.5 million kilometers of pipeline worldwide. The United States has about 65% of the total, Russia has about 8%, and Canada has about 3%, thus about 75% of all pipeline is located in three countries.

Liquids and gases are transported in pipelines (any chemically stable substance can be sent through a pipeline). For instance, pipelines exist for the transport of products (such as crude and refined petroleum) and/or fuels (such as oil, natural gas and biofuels). Pipelines are useful for transporting water (for drinking or irrigation purposes) over long distances when the water needs to be moved over hills, or where canals or channels are poor choices due to considerations of evaporation, pollution, or environmental impact.

Oil pipelines are made from steel or plastic tubes which are usually buried. Natural gas (and similar gaseous fuels) are lightly pressurized into liquids known as natural gas liquids (NGLs). Natural gas pipelines are constructed of carbon steel. Highly toxic ammonia is theoretically the most dangerous substance to be transported through long-distance pipelines, but accidents have been rare. Hydrogen pipeline transport is the transportation of hydrogen through a pipe. District heating or tele-heating systems use a network of insulated pipes which transport heated water, pressurized hot water or sometimes steam to the customer.

### SUMMARY

It will be appreciated that there exists a need to mitigate (at least in part) at least one problem associated with the existing natural gas compressors (also called the existing technology). After much study of the known systems and methods with experimentation, an understanding of the problem and its solution has been identified and is articulated as follows:

Product is moved through a pipeline by pump stations, also called compressor stations or pipeline-transport compressors, positioned along the pipeline about every 60 to about 100 km (kilometers). In some cases, the pipeline-transport compressors may be located remotely relative to the electrical grid, and so it may be difficult to provide power on the pipeline-transport compressors. Even with the availability of grid power, the installation of overhead power lines (to the pump station) represents an extreme expense at about $285,000 per mile.

What is needed is a way to provide electric power to energize components located proximate to the pipeline-transport compressor, thereby reducing reliance on the electrical grid for powering the components.

To mitigate, at least in part, at least one problem associated with the existing technology, there is provided (in accordance with a major aspect) an apparatus. The apparatus includes (and is not limited to) a pipeline-transport compressor configured to receive, in use, a product stream (such as a natural-gas stream) from a pipeline. The pipeline-transport compressor is also configured to pressurize, in use, the product stream that was received from the pipeline. The pipeline-transport compressor is also configured to provide, to the pipeline, the product stream that was pressurized. A cooler unit is positioned relative to the pipeline-transport compressor. More specifically, the cooler unit is positioned relative to the pipeline-transport compressor to cool (A) the product (such as natural gas, flowable material, water, etc. that is carried by the pipeline), and (B) a water jacket of the compressor driver. The cooler unit is configured to receive, in use, a cooler air intake from the pipeline-transport compressor in such a way that removal of the cooler air intake by the cooler unit, in use, cools the pipeline-transport compressor. The air exhaust power generation unit is positioned relative to the cooler unit. The air exhaust power generation unit is configured to generate, in use, electric power in response to the cooler unit, in use, urging, at least in part, the cooler air intake toward, at least in part, the air exhaust power generation unit.

To mitigate, at least in part, at least one problem associated with the existing technology, there is provided (in accordance with a major aspect) a method. The method is for operating a pipeline-transport compressor. The method includes (and is not limited to): (A) receiving a product stream (such as a natural-gas stream) from a pipeline, (B) pressurizing the product stream that was received from the pipeline, (C) providing, to the pipeline, the product stream that was pressurized, (D) receiving a cooler air intake from the pipeline-transport compressor to a cooler unit in such a way that removal of the cooler air intake by the cooler unit, in use, cools the pipeline-transport compressor, and (E) using the air exhaust power generation unit to generate electric power in response to the cooler unit, in use, urging, at least in part, the cooler air intake toward, at least in part, the air exhaust power generation unit.

A technical effect, of amongst others, of the apparatus is the recovery of kinetic energy from the cooler air intake that passes through (exits or is exhausted), at least in part, from the cooler unit, in which the cooler air intake would otherwise be released to the atmosphere. The recovery of kinetic energy from the cooler air intake takes the form of electric power (or is used to generate electric power) via the air exhaust power generation unit. The electric power generated by the air exhaust power generation unit may be provided to energize components located proximate to the pipeline-transport compressor, thereby reducing reliance on the electrical grid for powering the component (or powering the pipeline-transport compressor).

Other aspects are identified in the claims.

Other aspects and features of the non-limiting embodiments may now become apparent to those skilled in the art upon review of the following detailed description of the non-limiting embodiments with the accompanying drawings.

This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

Other aspects are identified in the claims.

Other aspects and features of the non-limiting embodiments may now become apparent to those skilled in the art upon review of the following detailed description of the non-limiting embodiments with the accompanying drawings.

This Summary is provided to introduce concepts in simplified form that are further described below in the Detailed Description. This Summary is not intended to identify key features or essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a side view of an embodiment of an apparatus including a synergistic combination of a pipeline-transport compressor, a cooler unit, and an air exhaust power generation unit;

FIG. 2 depicts a perspective view of an embodiment of the cooler unit and the air exhaust power generation unit of FIG. 1;

FIG. 3 depicts a close-up perspective view of an embodiment of the air exhaust power generation unit of FIG. 1;

FIG. 4 depicts a bottom view of an embodiment of the air exhaust power generation unit of FIG. 1;

FIG. 5 depicts a front side view of an embodiment of the air exhaust power generation unit of FIG. 1;

FIG. 6 depicts a side view of an embodiment of the air exhaust power generation unit of FIG. 1; and

FIG. 7 depicts an exploded view of an embodiment of the air exhaust power generation unit of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted.

Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, but well-understood, elements that are useful or necessary in commercially feasible embodiments are often not depicted to provide a less obstructed view of the embodiments of the present disclosure.

### LISTING OF REFERENCE NUMERALS USED IN THE DRAWINGS

102 pipeline-transport compressor
104 cooler unit
105 cooler air intake
106 air exhaust power generation unit
108 air intake fan 108
110 air exhaust portal
111 cooler air exhaust (also called “air exhaust”)
112 stator assembly
114 power generation unit intake
116 power generation exhaust
118 fan assemblies, or fan assembly
120 shaft assembly
122 frame assembly
123 lateral member
124 screen assembly
126 side panel, or side panels
128 lateral panel
130 electrical connector
134 electrical distribution system
136 shaft support
900 product stream
902 pipeline

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of may be defined by the claims (in which the claims may be amended during patent examination after filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described.

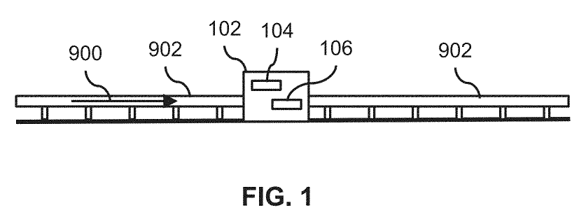

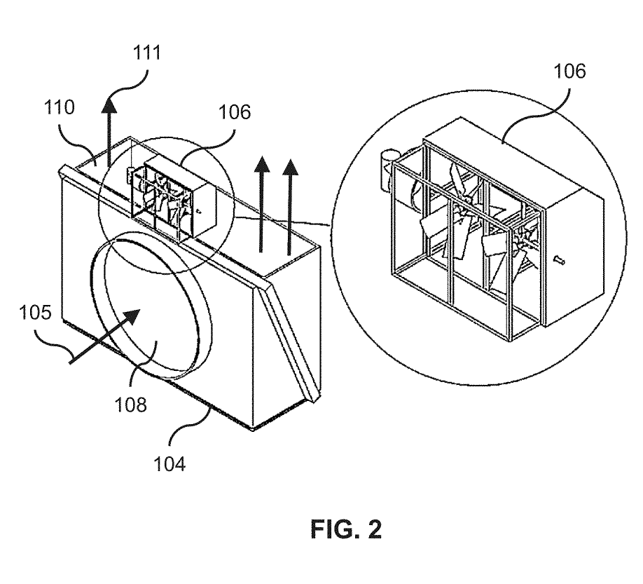

FIG. 1 depicts a side view of an embodiment of an apparatus including (and not limited to) a synergistic combination of a pipeline-transport compressor 102, a cooler unit 104, and an air exhaust power generation unit 106. FIG. 2 depicts a perspective view of an embodiment of the cooler unit 104 and the air exhaust power generation unit 106 of FIG. 1. An embodiment of the pipeline-transport compressor 102 may include a natural gas compressor, etc. It will be appreciated that compression is applied to pipeline as well to other components, such as well heads, etc.

Embodiments (and any equivalent thereof) of the pipeline-transport compressor 102 are manufactured by ENERFLEX (TRADEMARK) headquartered in Albert, Canada, EXTERRAN (TRADEMARK) headquartered in Texas, United States, BIDELL (TRADEMARK) headquartered in Albert, Canada, COMPASS (TRADEMARK) headquartered in Albert, Canada, and USA COMPRESSION (TRADEMARK) headquartered in Texas, United States. Although the pipeline-transport compressor 102 may be manufactured by different companies, the basic design is relatively standard, which reduces the need for custom designs of the pipeline-transport compressor 102.

Referring to the embodiments as depicted in FIGS. 1 and 2, the pipeline-transport compressor 102 is configured to receive (either directly or indirectly), in use, a product stream 900 (such as a natural-gas stream, a water stream, etc.) from a pipeline 902. The pipeline-transport compressor 102 is also configured to pressurize (either directly or indirectly), in use, the product stream 900 that was received from the pipeline 902. The pipeline-transport compressor 102 is also configured to provide (either directly or indirectly), to the pipeline 902, the product stream 900 that was pressurized.

The cooler unit 104 is positioned (either directly or indirectly) relative to the pipeline-transport compressor 102. The cooler unit 104 is coupled to (or connected to, either directly or indirectly) the pipeline-transport compressor 102. The cooler unit 104 is configured to receive, in use, a cooler air intake 105 (either directly or indirectly) from the pipeline-transport compressor 102. This is done in such a way that removal of the cooler air intake 105 by the cooler unit 104, in use, cools the pipeline-transport compressor 102. More specifically, removal of the cooler air intake 105 by the cooler unit 104, in use, moves cool air across the cooler bundles and out through the cooler unit 104. More specifically, the path of the cooler air intake 105, by the cooler unit 104, in use, moves air through the cooler bundles and out through the air exhaust portal 110. This is done in such a way that the air flow through the cooler air intake 105, the cooler unit 104, in use, cools the natural gas and the water jacket of the driver in the pipeline-transport compressor 102. More specifically, the cooler unit 104, is configured to receive, in use, the cooler air intake 105 (also called the fan driven atmospheric air intake). This is done in such a way that the air flow through the cooler air intake 105, by the cooler unit 104, in use, moves the cool air through the cooler bundles and out through the air exhaust portal 110, effectively cooling the natural gas and the water jacket in the pipeline-transport compressor 102.

The air exhaust power generation unit 106 is positioned relative to (preferably, being coupled to, either directly or indirectly) the cooler unit 104. The air exhaust power generation unit 106 is coupled to (or connected to, either directly or indirectly) the cooler unit 104. The air exhaust power generation unit 106 is configured to generate, in use, electric power. The generation of electric power (by the air exhaust power generation unit 106) is done in response to the cooler unit 104, in use, urging (either directly or indirectly), at least in part, the cooler air intake 105 toward, at least in part, the air exhaust power generation unit 106.

A technical effect, of amongst others, of the apparatus is the recovery of kinetic energy from the air flow that passes through (exits or is exhausted), at least in part, from the cooler unit 104, in which the cooler air intake 105 would otherwise be released to the atmosphere. The recovery of kinetic energy from the cooler air intake 105 takes the form of electric power (or is used to generate electric power) via the air exhaust power generation unit 106. The electric power generated by the air exhaust power generation unit 106 may be provided to energize components located proximate to the pipeline-transport compressor 102, thereby reducing reliance on the electrical grid for powering the component (or powering the pipeline-transport compressor 102).

In view of the foregoing and in accordance with an embodiment, there is provided a method of operating the pipeline-transport compressor 102. The method includes (and is not limited to) (A) receiving a product stream 900 from a pipeline 902, (B) pressurizing the product stream 900 that was received from the pipeline 902, (C) providing, to the pipeline 902, the product stream 900 that was pressurized, (D) receiving a cooler air intake 105 from the pipeline-transport compressor 102 to the cooler unit 104 in such a way that removal of the cooler air intake 105 by the cooler unit 104, in use, cools the pipeline-transport compressor 102, and (E) using the air exhaust power generation unit 106 to generate electric power in response to the cooler unit 104, in use, urging, at least in part, the cooler air intake 105 toward, at least in part, the air exhaust power generation unit 106.

The pipeline-transport compressor 102 is a mechanical device configured to increase the pressure of a gas by reducing its volume. The pipeline-transport compressor 102 is configured to increase the pressure of a fluid, and may transport the fluid through a pipe. As gases are compressible, the pipeline-transport compressor 102 also reduces the volume of a gas. Liquids are relatively incompressible; while some can be compressed, the main action of the pipeline-transport compressor 102 is to pressurize and transport natural gas along the pipeline 902. The pipeline-transport compressor 102 is configured to compress natural gas in the pipeline 902. For instance, the pipeline-transport compressor 102 is positioned about every 40 kilometers along the pipeline 902, or where needed.

In addition, the cooler unit 104 is configured to cool down the natural gas that is moved along the pipeline 902 by the pipeline-transport compressor 102. It will be appreciated that the cooler unit 104 includes an air-movement system (such as a fan, etc., known and not depicted), in which the air-movement system is mounted in the interior of the cooler unit 104. The cooler unit 104 includes an air intake fan 108. The cooler unit 104 includes an air exhaust portal 110 from which a cooler air exhaust 111, in use, flows therefrom.

The air exhaust power generation unit 106 is positioned in such a way that the air exhaust power generation unit 106 receives at least some of the cooler air intake 105 flowing through the cooler unit 104. The air exhaust power generation unit 106 is configured to not adversely interfere with the components of the cooler unit 104.

Preferably, under controlled conditions, electrical energy generation and production by way of consistent air flow can be increased from about 30% to about 100% capacity by using the air exhaust power generation unit 106. For instance, in accordance with an embodiment, the air exhaust power generation unit 106 may be configured to generate about 18,000 to about 24,000 kilowatt hours (kWh) per annum of decentralized electric power (power that is not provided from the electrical grid) that may be consumed at the source (at or by the pipeline-transport compressor 102). With increased transmission costs, the air exhaust power generation unit 106 provides a way to reduce the expense of buying electric power from the electrical grid. For remote facilities where the electrical grid is not available, the air exhaust power generation unit 106 is configured to produce at least some of the electric power needed to meet the operational needs of the remote facility. The air exhaust power generation unit 106 may provide a cost effective source of energy.

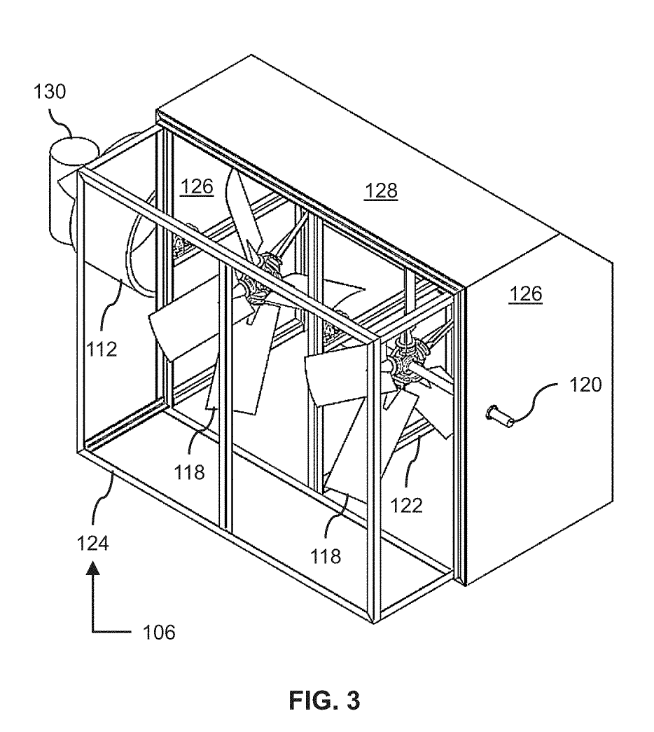

FIG. 3 depicts a close-up perspective view of an embodiment of the air exhaust power generation unit 106 of FIG. 1. Referring to the embodiment as depicted in FIG. 3, the air exhaust power generation unit 106 includes a frame assembly 122 configured to be attached to the cooler unit 104. Preferably, the frame assembly 122 is installed over the air exhaust of the cooler unit 104. More preferably, the air exhaust power generation unit 106 includes a frame assembly 122 that is installed over the air exhaust portal 110, to maximize exposure to the cooler air exhaust 111. Generally, the frame assembly 122 is installed over (or attached to) the interior of the cooler unit 104, and is mounted within the interior (to the interior side wall) of the cooler unit 104. Preferably, the frame assembly 122 includes spaced-apart frame sections joined by a lateral member 123.

The air exhaust power generation unit 106 further includes a shaft assembly 120 that is supported (mounted to) by the frame assembly 122. That is, the shaft assembly 120 is configured to be rotated relative to the frame assembly 122. More preferably, the frame assembly 122 includes a shaft support 136 (such as a pillow block bearing, and any equivalent thereof) configured to receive and support the shaft assembly 120. The shaft support 136 may be called a shaft support bearing.

The air exhaust power generation unit 106 further includes a fan assembly 118 that is affixed to a portion of the shaft assembly 120. The fan assembly 118 may be called an exhaust fan or an exhaust fan assembly. It will be appreciated that the number of fan assemblies 118 may be mounted (affixed) to the shaft assembly 120 for the case where there is a need to increase or decrease the rotational speed of the shaft assembly 120.

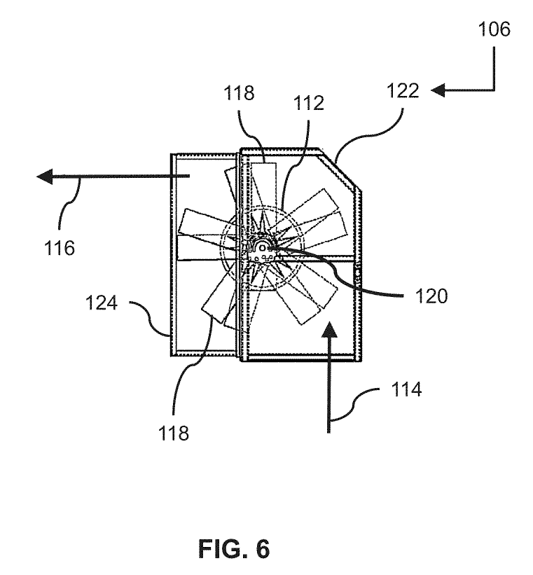

The air exhaust power generation unit 106 further includes a stator assembly 112 (also called turbine or power generation turbine assembly). Preferably, the stator assembly 112 is mounted to, and supported by, the frame assembly 122. The stator assembly 112 includes a stator shaft that is coupled (directly or indirectly) to the shaft assembly 120. The stator assembly 112 is configured to be rotated by the shaft assembly 120 in response to the fan assembly 118 receiving a flow of air (as depicted in FIG. 6) received by the power generation unit intake 114 of the air exhaust power generation unit 106, in which the air flow is provided by the cooler unit 104 (as depicted in FIG. 2). Once the stator assembly 112 is rotated, the stator assembly 112 generates electricity. The power generation unit intake 114 may be called an air intake.

An embodiment of the stator assembly 112 includes the VENTERA (TRADEMARK) Model VT10 Turbine unit (and any equivalent thereof), which is a 10 kilowatt unit. VENTERA is headquartered in Minnesota, United States. Another embodiment of the stator assembly 112 includes the BERGEY (TRADEMARK) Excel 10 Turbine Unit (and any equivalent thereof), which is a 10 kilowatt unit. BERGEY is headquartered in Oklahoma, United States.

The air exhaust power generation unit 106, further includes an electrical connector 130 that is electrically connected to the stator assembly 112. The electricity generated by the stator assembly 112 is provided to the electrical connector 130.

The stator assembly 112 includes an electrical connection (electrical cable) (known and not depicted) having the electrical connector 130 configured to be attached to an inverter (known and not depicted). It will be appreciated that many different inverter units are available from various manufacturers, such as the inverter unit manufactured by VENTERA. VENTERA manufactures a cabinet assembly (known and not depicted) that contains the GINLONG (TRADEMARK) rectifier, the GINLONG inverter, and the GINLONG transformer, and any equivalent thereof. GINLONG is headquartered in Zhejiang, China.

In summary, the air exhaust power generation unit 106 is configured to exploit waste or fugitive airflow from the cooler unit 104 (compressor cooler package) of a pipeline-transport compressor 102, and is also configured to generate electric power (perhaps sufficient enough to make a compressor station independent of the electrical grid or better to sell power back to the electrical grid). The stator assembly 112 utilizes air flow via the fan assembly 118 to generate electricity.

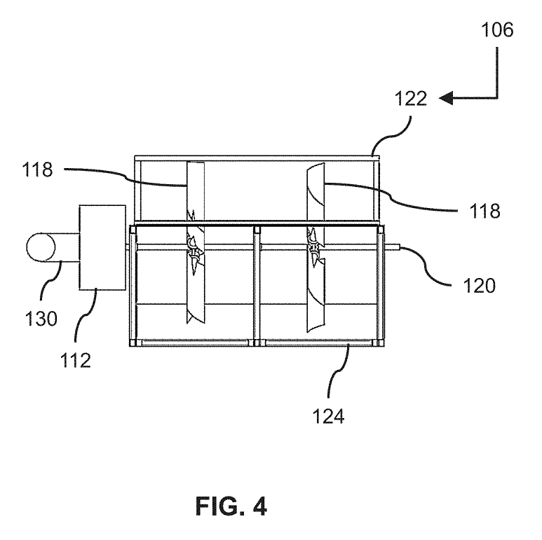

FIG. 4 depicts a bottom view of an embodiment of the air exhaust power generation unit 106 of FIG. 1. Referring to the embodiment as depicted in FIG. 4, the bottom section of the frame assembly 122 is open, at least in part, so that the interior of the air exhaust power generation unit 106 is in fluid communication with the cooler unit 104 (as depicted in FIG. 2).

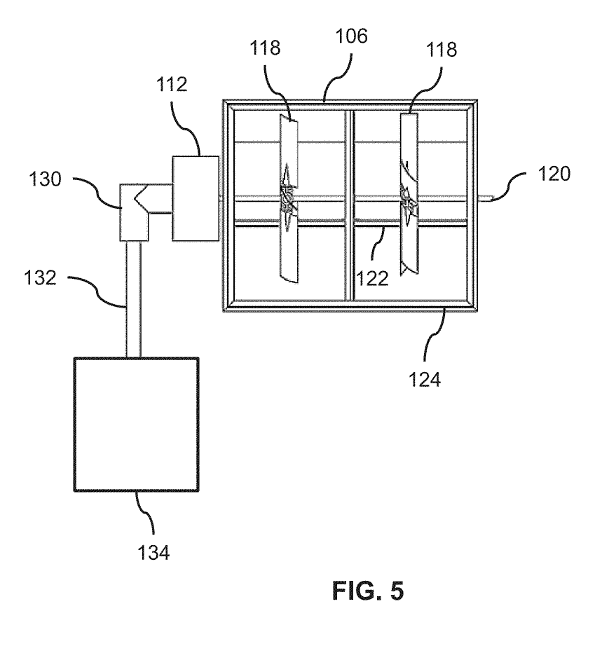

FIG. 5 depicts a front side view of an embodiment of the air exhaust power generation unit 106 of FIG. 1. Referring to the embodiment as depicted in FIG. 5, the air exhaust power generation unit 106 further includes the electrical connector 130 that is electrically connected to the stator assembly 112. The electricity generated by the stator assembly 112 is provided to the electrical connector 130. An electrical distribution system 134 may include the utility (the electrical grid) or an electrical distribution panel. The electrical distribution system 134 is configured to receive, in use, electric power from the stator assembly 112 via the electrical connector 130.

FIG. 6 depicts a side view of an embodiment of the air exhaust power generation unit 106 of FIG. 1. Referring to the embodiment as depicted in FIG. 6, the power generation unit intake 114 of the cooler unit 104 receives the air flow from the cooler unit 104. The power generation exhaust 116 of the air exhaust power generation unit 106 provides exhaust air from the air exhaust power generation unit 106. The power generation exhaust 116 may be called an air exhaust.

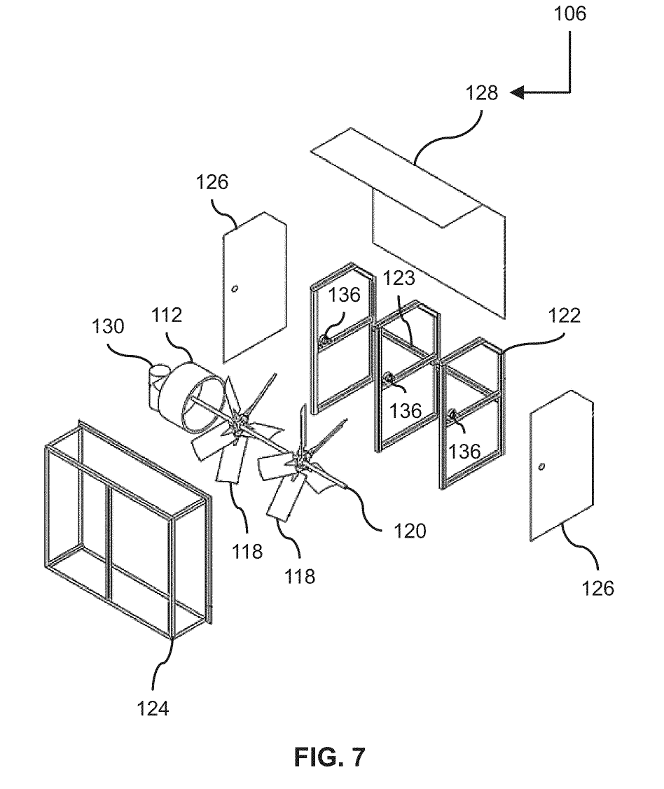

FIG. 7 depicts an exploded view of an embodiment of the air exhaust power generation unit 106 of FIG. 1. Referring to the embodiment as depicted in FIG. 7, the air exhaust power generation unit 106 further includes a side panel 126 that is affixed to a side section of the frame assembly 122. Preferably, side panels 126 are respectively affixed to opposite lateral side sections of the frame assembly 122. The air exhaust power generation unit 106 further includes a lateral panel 128 that is affixed to the frame assembly 122. Preferably, the lateral panel 128 is positioned between the side panels 126. The air exhaust power generation unit 106 further includes a screen assembly 124 that is mounted to the frame assembly 122. The screen assembly 124 provides an air input portal for the air exhaust power generation unit 106. The screen assembly 124 is mounted to the frame assembly 122. The screen assembly 124 provides an air input portal (also called the power generation unit intake 114) for the air exhaust power generation unit 106.

It will be appreciated that the description and/or drawings identify and describe embodiments of the apparatus (either explicitly or non-explicitly). The apparatus may include any suitable combination and/or permutation of the technical features as identified in the detailed description, as may be required and/or desired to suit a particular technical purpose and/or technical function. It will be appreciated, that where possible and suitable, any one or more of the technical features of the apparatus may be combined with any other one or more of the technical features of the apparatus (in any combination and/or permutation). It will be appreciated that persons skilled in the art would know that technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help understand the scope of the claims. It is believed that all the crucial aspects of the disclosed subject matter have been provided in this document. It is understood, for this document, that the phrase “includes” is equivalent to the word “comprising.” The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a pipeline-transport compressor being configured to receive, in use, a product stream from a pipeline; and
the pipeline-transport compressor also being configured to pressurize, in use, the product stream that was received from the pipeline; and
the pipeline-transport compressor also being configured to provide, to the pipeline, the product stream that was pressurized; and
a cooler unit being positioned relative to the pipeline-transport compressor; and
the cooler unit being configured to receive, in use, a cooler air intake from the pipeline-transport compressor in such a way that removal of the cooler air intake by the cooler unit, in use, cools the pipeline-transport compressor; and
an air exhaust power generation unit being positioned relative to the cooler unit; and
the air exhaust power generation unit being configured to generate, in use, electric power in response to the cooler unit, in use, urging, at least in part, the cooler air intake toward, at least in part, the air exhaust power generation unit.

2. The apparatus of claim 1, wherein:
the cooler unit is coupled to (or connected to) the pipeline-transport compressor; and
the air exhaust power generation unit is coupled to (or connected to) the cooler unit.

3. The apparatus of claim 1, wherein:
the cooler unit includes an air-movement system mounted in the interior of the cooler unit.

4. The apparatus of claim 1, wherein:
the cooler unit includes an air intake fan; and
an air exhaust portal from which a cooler air exhaust, in use, flows therefrom.

5. The apparatus of claim 1, wherein:
the air exhaust power generation unit is positioned in such a way that the air exhaust power generation unit receives at least some of the cooler air intake flowing through the cooler unit; and
the air exhaust power generation unit is configured to not adversely interfere with components of the cooler unit.

6. The apparatus of claim 1, wherein:
the air exhaust power generation unit receives air flow from the cooler unit; and
an power generation exhaust of the air exhaust power generation unit provides exhaust air from the air exhaust power generation unit.

7. The apparatus of claim 1, wherein:
the air exhaust power generation unit includes:
a frame assembly being installed over an air exhaust of the cooler unit; and
the frame assembly being mounted to the top of the cooler unit.

8. The apparatus of claim 7, wherein:
the air exhaust power generation unit further includes:
side panels being respectively affixed to opposite lateral side sections of the frame assembly; and
a lateral panel being affixed to the top of the frame assembly; and
the lateral panel being positioned between the side panels.

9. The apparatus of claim 7, wherein:
the air exhaust power generation unit further includes:
a screen assembly being mounted to the frame assembly; and the screen assembly providing a power generation unit intake for the air exhaust power generation unit.

10. The apparatus of claim 7, wherein:
a bottom section of the frame assembly is open, at least in part, so that the interior of the air exhaust power generation unit is in fluid communication with the cooler unit.

11. The apparatus of claim 7, wherein:
the frame assembly includes spaced-apart frame sections joined by a lateral member.

12. The apparatus of claim 7, wherein:
the air exhaust power generation unit further includes:
a shaft assembly being supported by the frame assembly; and
the shaft assembly being configured to be rotated relative to the frame assembly.

13. The apparatus of claim 12, wherein:
the frame assembly includes:
a shaft support being configured to receive and support the shaft assembly.

14. The apparatus of claim 12, wherein:
the air exhaust power generation unit further includes:
a fan assembly being affixed to a portion of the shaft assembly.

15. The apparatus of claim 14, wherein:
the air exhaust power generation unit further includes:
a stator assembly being mounted to, and supported by, the frame assembly; and
the stator assembly including a stator shaft being coupled to the shaft assembly; and
the stator assembly being configured to be rotated by the shaft assembly in response to the fan assembly receiving a flow of air received by an power generation unit intake of the air exhaust power generation unit, in which air flow is provided by the cooler unit, and once the stator assembly is rotated, the stator assembly generates electricity.

16. The apparatus of claim 15, wherein:
the air exhaust power generation unit is configured to:
exploit waste or fugitive airflow from the cooler unit of the pipeline-transport compressor; and
generate the electric power.

17. The apparatus of claim 15, wherein:
the air exhaust power generation unit further includes:
an electrical connector being electrically connected to the stator assembly, in which the electricity generated by the stator assembly is provided to the electrical connector.

18. The apparatus of claim 17, wherein:
the air exhaust power generation unit further includes:
an electrical distribution system configured to receive, in use, the electric power from the stator assembly via the electrical connector.

19. An apparatus, comprising:
a pipeline-transport compressor being configured to receive, in use, a product stream from a pipeline; and
the pipeline-transport compressor also being configured to pressurize, in use, the product stream that was received from the pipeline; and
the pipeline-transport compressor also being configured to provide, to the pipeline, the product stream that was pressurized; and
a cooler unit being positioned relative to the pipeline-transport compressor; and
the cooler unit being configured to receive, in use, a cooler air intake from the pipeline-transport compressor in such a way that removal of the cooler air intake by the cooler unit, in use, moves cool air across cooler bundles and out through the cooler unit, and
an air exhaust power generation unit being positioned relative to the cooler unit; and
the air exhaust power generation unit being configured to generate, in use, electric power in response to the cooler unit, in use, urging, at least in part, the cooler air intake toward, at least in part, the air exhaust power generation unit; and
wherein:
the air exhaust power generation unit includes:
a frame assembly being attached to the interior of the cooler unit; and
the frame assembly being mounted to the top of the cooler unit; and
side panels being respectively affixed to opposite lateral side sections of the frame assembly; and
a lateral panel being affixed to the frame assembly; and
the lateral panel being positioned between the side panels; and
a screen assembly being mounted to the frame assembly; and the screen assembly providing an air input portal for the air exhaust power generation unit; and
a bottom section of the frame assembly is open, at least in part, so that the interior of the air exhaust power generation unit is in fluid communication with the cooler unit; and
a shaft assembly being supported by the frame assembly; and
the shaft assembly being configured to be rotated relative to the frame assembly; and
a fan assembly being affixed to a portion of the shaft assembly; and
a stator assembly being mounted to, and supported by, the frame assembly; and
the stator assembly including a stator shaft being coupled to the shaft assembly; and
the stator assembly being configured to be rotated by the shaft assembly in response to the fan assembly receiving a flow of air received by an power generation unit intake of the air exhaust power generation unit, in which air flow is provided by the cooler unit, and once the stator assembly is rotated, the stator assembly generates electricity; and
an electrical connector being electrically connected to the stator assembly, in which the electricity generated by the stator assembly is provided to the electrical connector.

20. A method of operating a pipeline-transport compressor, the method comprising:
receiving a product stream from a pipeline; and
pressurizing the product stream that was received from the pipeline; and
providing, to the pipeline, the product stream that was pressurized; and
receiving a cooler air intake from the pipeline-transport compressor to a cooler unit in such a way that removal of the cooler air intake by the cooler unit, in use, cools the pipeline-transport compressor; and
using an air exhaust power generation unit to generate electric power in response to the cooler unit, in use, urging, at least in part, the cooler air intake toward, at least in part, the air exhaust power generation unit.
